(19) United States
(12) Patent Application Publication
(10) Pub. No.: US 2023/0180972 A1
(43) Pub. Date: Jun. 15, 2023

(54) Shop Towel Device

(71) Applicants: Derek Konasiewicz, Barnegat, NJ (US); Ann Konasiewicz, Barnegat, NJ (US)

(72) Inventors: Derek Konasiewicz, Barnegat, NJ (US); Ann Konasiewicz, Barnegat, NJ (US)

(21) Appl. No.: 17/549,117

(22) Filed: Dec. 13, 2021

(51) Int. Cl. A47K 10/16; A41D 27/12; B32B 7/06; B32B 27/10; B32B 25/06

(52) U.S. Cl. CPC A47K 10/16; A41D 27/12; B32B 7/06; B32B 27/10; B32B 25/06; B32B 2250/03; B32B 2405/00; B32B 2432/00; B32B 2307/732; A47G 11/002

(57) ABSTRACT

A shop towel device adheres to and covers the exterior of a garment to allow for wiping of the hands without soiling the garment. The device includes a base layer, the base layer being impermeable by fluids. An outer layer is coupled to and coextensive with the base layer. The outer layer is constructed of a fluid absorbent material. An inner layer is coupled to the base layer such that the base layer is between the outer layer and the inner layer. The inner layer is adherent for adhering to a garment such that the outer layer is exposed on the garment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shop towels and more particularly pertains to a new shop towels for adhering to and covering the exterior of a garment to allow for wiping of the hands without soiling the garment.

### (2) Description of Related Art Including Information Disclosed Under 37 CFR 1.97 and 1.98

The prior art relates to shop towels.

### BRIEF SUMMARY OF THE INVENTION

An embodiment of the disclosure meets the needs presented above by generally comprising a base layer, the base layer being impermeable by fluids. An outer layer is coupled to and coextensive with the base layer. The outer layer is constructed of a fluid absorbent material. An inner layer is coupled to the base layer such that the base layer is between the outer layer and the inner layer. The inner layer is adherent for adhering to a garment such that the outer layer is exposed on the garment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a shop towel device according to an embodiment of the disclosure.

FIG. 2 is a side view of an embodiment of the disclosure.

FIG. 3 is a front view of an embodiment of the disclosure in use.

FIG. 4 is a side view of an embodiment of the disclosure.

FIG. 5 is a top view of an embodiment of the disclosure.

FIG. 6 is a top view of an embodiment of the disclosure.

FIG. 7 is a top view of an embodiment of the disclosure.

FIG. 8 is a top view of an embodiment of the disclosure.

### DETAILED DESCRIPTION OF THE INVENTION

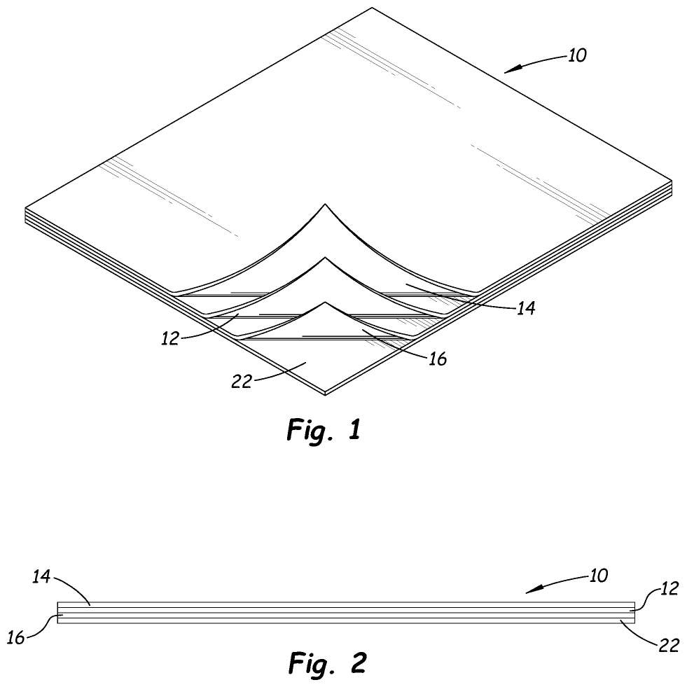

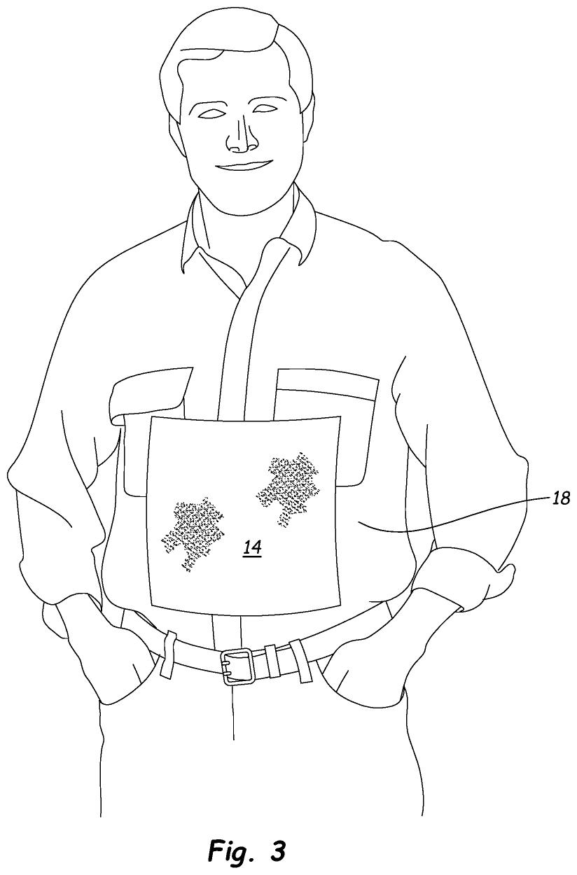

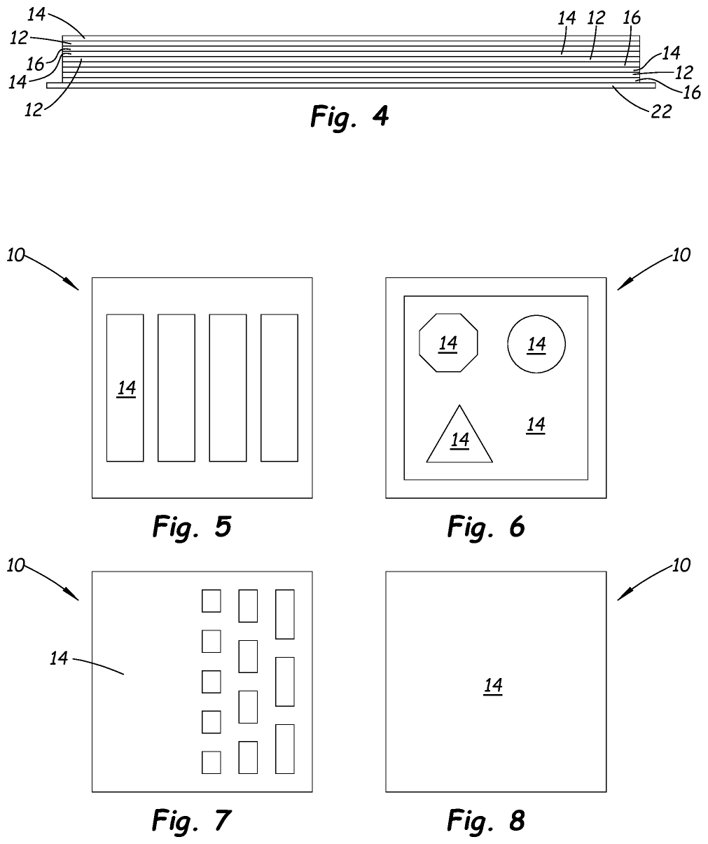

With reference now to the drawings, and in particular to FIGS. 1 through 8 thereof, a new shop towels embodying the principles and concepts of an embodiment of the disclosure and generally designated by the reference numeral 10 will be described.

As best illustrated in FIGS. 1 through 8, the shop towel device 10 generally comprises a base layer 12. The base layer 12 is impermeable by fluids. The base layer 12 is constructed of one of a plastic material and a rubber material. An outer layer 14 is coupled to and is coextensive with the base layer 12. The outer layer 14 is constructed of a fluid absorbent material. The fluid absorbent material is a paper material. The paper material is contemplated to be a substance made primarily from wood pulp but may be made from rags, straw, or other fibrous material in a thin sheet. An inner layer 16 is coupled to the base layer 12 such that the base layer 12 is between the outer layer 14 and the inner layer 16. The inner layer 16 is adherent wherein the inner layer 16 is configured for adhering to a garment 18 such that the outer layer 14 is exposed on the garment 18. The inner layer being adherent is contemplated to include the inner layer 16 being a layer of adhesive which may or may not include a substrate to facilitate adherence of the inner layer 16 to the base layer 12.

A cover layer 22 is removably coupled to and covers the inner layer 16. The cover layer 22 has a peripheral edge 24 which is offset from a perimeter edge 26 of the inner layer 16 such that the cover layer 22 extends outwardly from the perimeter edge 26 of the inner layer 16. The cover layer 22 is constructed of a wax paper material defined generally as a paper material covered by or impregnated by a wax substance to facilitate removing of the cover layer 22 from the inner layer 16.

Each of the base layer 12, the outer layer 14, and the inner layer 16 is rectangular. The size of the shop towel device 10 is such that it is sufficiently large to facilitate wiping of a hand on the outer layer 14 and absorption of any substance on the hands without the substance being wiped off of the outer layer 14 and onto the garment 18. It is contemplated the thinness of the outer layer 14 will result in saturation of the outer layer 14 in the immediate area where the hands are wiped but the size will allow for wiping in unsaturated areas to sufficiently clean the hands. As such, each of the base layer 12, the outer layer 14, and the inner layer 16 has a length greater than 6 inches and up to 24 inches, although the length may further be greater than 24 inches. Each of the base layer 12, the outer layer 14, and the inner layer 16 has a width greater than 6 inches and up to 24 inches, although the length may further be greater than 24 inches.

The base layer 12, outer layer 14, and inner layer 16 may also be stacked in sequence such that removal of the inner layer 16 from the outer layer 14 of an adjacently stacked shop towel device 10 also for sequential dispensing of individual sheets. The cover layer 22 may be attached to the inner layer 16 of a bottommost positioned shop towel device 10 in the stack.

In alternative embodiments, the inner layer 16, base layer 12, and outer layer 14 may be cut into a plurality of geometric shapes on the cover layer 22 to allow for the geometric shapes to be removed from the cover layer 22 and positioned on the garment 18 in a desired place. The geometric shapes may be large enough to allow for wiping of the hands or sized to allow for specific placement to cover a desired portion of the garment 18.

In use, the cover layer 22 is removed from the inner layer 16 and the inner layer 16 is positioned in a desired place on the garment 18. The shop towel device 10 adheres to the garment 18. The shop towel device 10 is positioned on the garment 18 in an area easily accessed for wiping a hand on the outer layer 14. When done or the outer layer 14 is substantially or fully saturated, the shop towel device 10 can be removed from the garment 18 and thrown away. If needed another shop towel device 10 can be placed onto the garment 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A shop towel device comprising:
a base layer, said base layer being impermeable by fluids;
an outer layer coupled to and being coextensive with said base layer, said outer layer being constructed of a fluid absorbent material; and
an inner layer, said inner layer being coextensive with and coupled to said base layer such that said base layer is positioned entirely between said outer layer and said inner layer, said inner layer being adherent wherein said inner layer is configured for adhering to a garment such that said outer layer is exposed on the garment.

2. The shop towel device of claim 1, further comprising a cover layer removably coupled to and covering the inner layer.

3. The shop towel device of claim 2, wherein said cover layer has a peripheral edge being offset from a perimeter edge of said inner layer such that said cover layer extends outwardly from said perimeter edge of said inner layer.

4. The shop towel device of claim 1, further comprising each of said base layer, said outer layer, and said inner layer being rectangular.

5. The shop towel device of claim 4, further comprising each of said base layer, said outer layer, and said inner layer has a length between 6 inches and 24 inches and a width between 6 inches and 24 inches.

6. The shop towel device of claim 4, further comprising each of said base layer, said outer layer, and said inner layer has a length greater than 10 inches.

7. The shop towel device of claim 6, further comprising each of said base layer, said outer layer, and said inner layer has a width greater than 10 inches.

8. The shop towel device of claim 1, further comprising said fluid absorbent material being a paper material.

9. The shop towel device of claim 1, further comprising said base layer being constructed of a plastic material.

10. The shop towel device of claim 1, further comprising said base layer being constructed of a rubber material.

11. The shop towel device of claim 2, further comprising said cover layer being constructed of a wax paper material.

12. The shop towel device of claim 2, further comprising a size of said cover layer being larger than a size of said inner layer wherein a peripheral edge of said cover layer is outwardly offset from a perimeter edge of said inner layer to facilitate peeling of said cover layer from said inner layer.

13. A shop towel device comprising:
a base layer, said base layer being impermeable by fluids, said base layer being constructed of one of a plastic material and a rubber material;
an outer layer coupled to and being coextensive with said base layer, said outer layer being constructed of a fluid absorbent material, said fluid absorbent material being a paper material;
an inner layer, said inner layer being coextensive with and coupled to said base layer such that said base layer is positioned entirely between said outer layer and said inner layer, said inner layer being adherent wherein said inner layer is configured for adhering to a garment such that said outer layer is exposed on the garment;
a cover layer removably coupled to and covering the inner layer, said cover layer has a peripheral edge being offset from a perimeter edge of said inner layer such that said cover layer extends outwardly from said perimeter edge of said inner layer, said cover layer being constructed of a wax paper material;
each of said base layer, said outer layer, and said inner layer being rectangular, each of said base layer, said outer layer, and said inner layer having a length greater than 10 inches, each of said base layer, said outer layer, and said inner layer having a width greater than 10 inches.
